(19) United States
(12) Patent Application Publication
(10) Pub. No.: US 2012/0005859 A1
(43) Pub. Date: Jan. 12, 2012

(54) STRAP HINGE FOR THE CONNECTION OF A LEAF TO A FRAME SO AS TO BE PIVOTABLE ABOUT A HINGE AXIS

(75) Inventors: Tibor Herglotz, Kreuzau (DE); Ingo Steinfeld, Langenfeld (DE)

(73) Assignee: Dr. Hahn GmbH & Co. KG, Moenchengladbach-Wickrath (DE)

(21) Appl. No.: 13/175,895

(22) Filed: Jul. 4, 2011

(30) Foreign Application Priority Data
Jul. 8, 2010 (DE) 20 2010 008 013.4

(51) Int. Cl. E05D 7/06

(52) U.S. Cl. 16/241; 16/239

(57) ABSTRACT

A strap hinge for connecting a leaf to a frame so as to pivot about a hinge axis includes a first joint hinge with a first fastening part and a first hinge part. A second joint hinge with a second fastening part and a second hinge part is connected to the second joint hinge so as to pivot about the hinge axis. The second hinge part is configured so as to tilt about a tilt axis extending approximately parallel to the hinge axis. The tilt axis is defined by at least one contact surface, which is curved in a circle-like shape. The at least one contact surface is arranged on the strap hinge receiving element and is configured to abut against a respective counter contact surface arranged on the second fastening part. The respective counter contact surface is curved in an approximately complementary manner to the at least one contact surface.

### CROSS REFERENCE TO PRIOR APPLICATIONS

Priority is claimed to German Patent Application No. DE 20 2010 008 013.4, filed Jul. 8, 2010. The entire disclosure of said application is incorporated by reference herein.

### FIELD

The present invention relates to a strap hinge for the connection of a leaf to a frame so as to be pivotable about a hinge axis. The strap hinge has a first joint hinge, which has a first fastening part and a first hinge part and is connected, so as to be pivotable about the hinge axis, to a second joint hinge, which has a second fastening part and a second hinge part. The second hinge part of the second joint hinge is arranged in a strap hinge receiving element so as to be tiltable about a tilt axis that extends approximately parallel to the hinge axis.

### BACKGROUND

DE 10 2007 019 938 B3 describes a strap hinge where the second fastening part has, on its end remote from the second hinge part, projections which are guided in vertical slots in the strap hinge receiving element. The guiding defines the tilt axis about which the second hinge part can be tilted inside the strap hinge receiving part for the purposes of an adjustment perpendicularly to the hinge axis.

A disadvantage of the strap hinge described in DE 10 2007 019 938 B3 is that on account of the ever present play with which the projections engage in the slots, the tilt axis is not defined in a precise manner, so that the achievable adjusting accuracy deteriorates. Furthermore, during an adjustment operation, the hinge axis is moved over an arc of a circle, the radius of which is determined by the spacing between the tilt axis and the hinge axis, such that an adjustment by tilting the second joint hinge about the tilt axis is always associated with an unwanted displacement of the hinge axis perpendicularly to the adjusting direction.

### SUMMARY

An aspect of the present invention is to provide an improved strap hinge with regard to the aforementioned disadvantages.

In an embodiment, the present invention provides a strap hinge for connecting a leaf to a frame so as to pivot about a hinge axis which includes a first joint hinge with a first fastening part and a first hinge part, and a second joint hinge with a second fastening part and a second hinge part, the second hinge part being arranged in a strap hinge receiving element. The first joint hinge is connected to the second joint hinge so as to pivot about the hinge axis. The second hinge part is configured so as to be tiltable about a tilt axis extending approximately parallel to the hinge axis. The tilt axis is defined by at least one contact surface, which, when viewed in the direction of the tilt axis, is curved in a shape of a part of a circle. The at least one contact surface is arranged on the strap hinge receiving element and configured to abut against a respective counter contact surface arranged on the second fastening part. The respective counter contact surface is curved in an approximately complementary manner to the at least one contact surface.

### BRIEF DESCRIPTION OF THE DRAWINGS

The present invention is described in greater detail below on the basis of embodiments and of the drawings in which:

FIG. 1 shows a view perpendicular to the hinge axis of the side of the strap hinge facing away from the observer in the mounted state (also called “rear side”);

FIG. 2 shows a perspective view of the side of the strap hinge facing the observer in the mounted state;

FIG. 3 shows a view of the strap hinge as in FIG. 2 in a state mounted on a schematically shown frame and a schematically shown leaf;

FIG. 4 shows a view corresponding to FIG. 3, but in the state of the two joint hinges separated after removing the locking element and the strap hinge bolt;

FIG. 5 shows a perspective exploded view of the second joint hinge and the strap hinge receiving element;

FIGS. 6a) to d) show different views of the first joint hinge with adjusting and bearing sleeves;

FIG. 7 shows a section in the direction of the hinge axis through the upper, first hinge part and the second hinge part in the interconnected state;

FIGS. 8a) to c) show sections according to section line VIII in FIG. 3, but with the leaf closed in different adjustment positions perpendicular to the hinge axis;

FIG. 9 shows a section according to section line IX in FIG. 3, once again with the leaf closed;

FIG. 10 shows a view corresponding to FIG. 9 according to section line X in FIG. 3;

FIG. 11 shows an enlarged representation of the view as in FIG. 8c) of the second joint hinge and the strap hinge receiving element; and

FIGS. 12a) to c) show a longitudinal section of the strap hinge through the hinge axis with the leaf closed in different adjustment positions in the direction of the hinge axis.

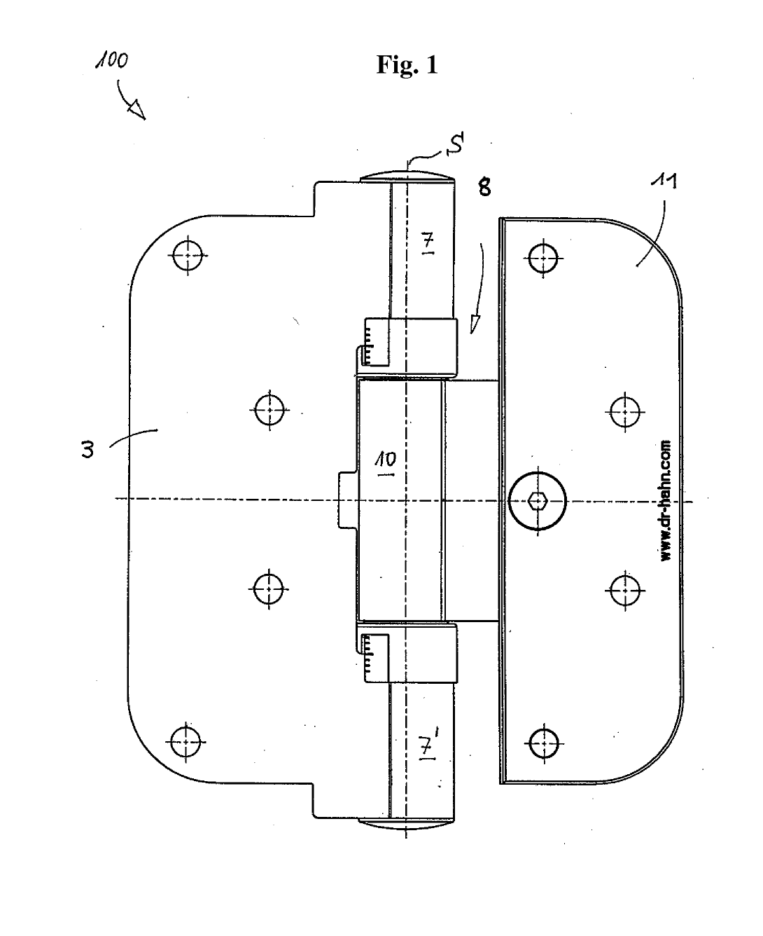

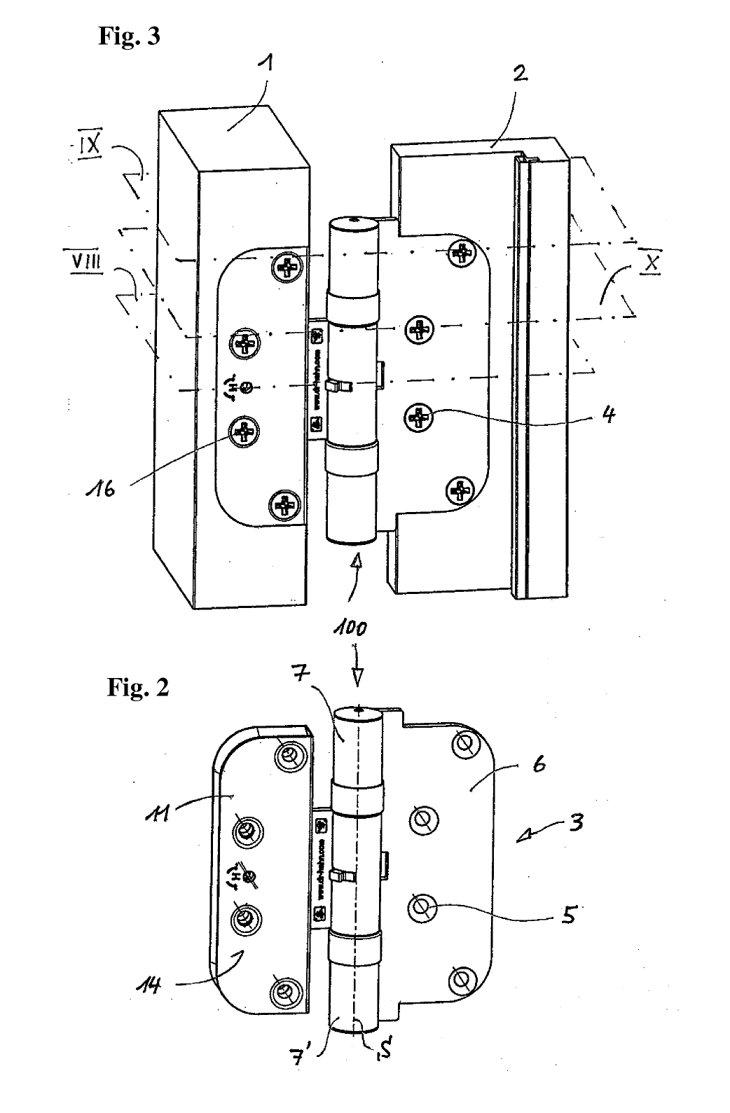

### DETAILED DESCRIPTION

In an embodiment of the present invention, two counter contact surfaces, which are at a constant spacing from each other, can be provided on the second fastening part and two contact surfaces, which are complementary to the counter contact surfaces, can be provided on the strap hinge receiving element, the spacing between the contact surfaces corresponding at least approximately to the spacing between the counter contact surfaces. In other words, the contact and counter contact surfaces are arranged concentrically such that the fastening part is able to be displaced about the tilt axis with flat contact on both sides. This development is distinguished, consequently, by a particular lack of play.

It has been shown that where the strap hinge receiving element has a thickness which still enables adjustment lengths of +/−5 mm from the central position, usually considered desirable in the case of door leaves, it is possible to achieve compensation, sufficient in the majority (if not in all) of cases, of the movement component perpendicular to the adjusting direction if the contact surfaces and the counter contact surfaces have flat radii of curvature which cause the tilt axis to be outside the second fastening part. The length of the unwanted movement component perpendicular to the adjusting direction can be influenced by selecting the radii of curvature.

The advantages achievable with the strap hinge according to the present invention are independent of the means provided for bringing about the tilt movement of the second fastening part about the tilt axis. Due to its simplicity of production and precise actuatability, one embodiment of the strap hinge according to the present invention can, for example, have an adjusting screw which, can, for example, be received in a threaded bore of the second fastening part and which can be supported by way of its two ends on inner surfaces of the strap hinge receiving element. If the thread pitches of the adjusting screw and of the threaded bore are selected to be self-locking (also on account of the at least almost play-free bearing arrangement of the second fastening part in the strap hinge receiving element), no further measures are necessary to fix the second fastening part in an adjustment position achieved by rotating the adjustment screw.

On account of the flat abutment, an almost play-free bearing arrangement of the second fastening part in the joint hinge receiving element can be achieved even during an adjustment operation. The tilting of the second fastening part then takes place about a tilt axis which is at a spacing perpendicularly from the second fastening part approximately by the radius of curvature of the contact surface. The length of the regularly unwanted movement component occurring perpendicularly to the adjustment direction is therefore able to be reduced so that the adjusting accuracy achievable with the strap hinge according to the present invention is improved compared to the prior art.

In an embodiment of the present invention, the adjustment screw can, for example, be provided on the end region of the second fastening part remote from the second hinge part. In the case of this embodiment of the strap hinge, the adjusting screw can be situated not between the bearing arrangement of the second fastening part defining the tilt axis and the second hinge part, but rather the bearing arrangement defining the tilt axis can be effected between the adjustment screw and the second hinge part. The second fastening part, therefore, can be realized as a kind of rocker that can be pivotable about the tilt axis, at the one end region of which is situated the adjusting screw and at the other end region of which is situated the second hinge part. On account of this measure, the distance between the hinge axis and the tilt axis can be reduced such that forces absorbed by the second hinge part are introduced into the strap hinge receiving element by a shorter lever than in the prior art.

In an embodiment of the present invention, the strap hinge receiving element can be divided in a parting plane that extends parallel to the tilt axis and between the contact surfaces. Pre-assembly of the second joint hinge, the adjusting screw and the strap hinge receiving element to form one module can then be effected in a simple manner by first screwing the adjusting screw into the threaded bore of the second fastening part of the pre-assembled second joint hinge, inserting this into a part of the strap hinge receiving element and then mounting the other part.

In an embodiment of the present invention, the hinge axis can be defined by a strap hinge bolt which engages in the first and second hinge parts. The strap hinge bolt can have a region with a reduced diameter. In at least one of the first or second hinge parts there can be provided a receiving means, into which, with the leaf open, a locking element can be introduced, the locking element interacting in the introduced state with the region with a reduced diameter in such a manner that the strap hinge bolt cannot be removed from the first and second hinge parts without first removing the locking element. Releasing the connection between the first and the second joint hinges can consequently only be possible with the leaf open in a destruction-free manner once the locking element has been removed, as a result of which the taking of a closed leaf “off its hinges” in an unauthorized manner is made substantially more difficult.

Inventive significance is given to the afore-described development for securing the closed leaf from being removed from its hinges in an unauthorized manner independent of whether the strap hinge is one with a strap hinge receiving element of the afore-described type or is a conventional strap hinge.

In an embodiment of the present invention, the locking element can, for example, be clamping-fork-like so that, in the inserted state, the forks abut against the region with a reduced diameter, preferably with resilient prestressing. A locking element developed in this manner can be produced in a simple, cost-effective manner from flat material by means of stamping; in this case a simply producible slot, the cross section of which is adapted to that of the locking element, then serves as receiving means.

The strap hinge bolt can, for example, have an external thread on one end region and a complementary internal thread as the hinge part. The strap hinge bolt can then be moved into its desired position by being screwed-in and held in said position.

In an embodiment of the present invention, an internal thread, into which an adjusting spindle having a complementary external thread can be screwed can be provided on a hinge part. In addition, an adjusting spindle can be provided, which is supported by way of one end on the adjusting spindle and the other end thereof abutting against an end face of the other hinge part. By rotating the adjusting spindle, the contact surface can be displaced in the direction of the hinge axis and the strap hinge can be adjusted in this direction. On the adjusting sleeve there can, for example, be provided a circumferential collar which covers the outer periphery of the one hinge part at least in part, in order, in this manner, to bring about an unfractured outer physical appearance independent of the adjusting position. A protruding tongue with a scale on the outer surface thereof can be provided on the circumferential collar, by means of which scale the adjusting position at any one time can be read-off in the direction of the hinge axis. This measure, to which specific inventive significance is given even for prior art strap hinges, makes it easier, for example, after the leaf has been removed, to reproduce an adjusting position that was once found.

When the strap hinge is a so-called three-part strap hinge, where the first joint hinge comprises two first hinge parts which are spaced apart from each other in the direction of the hinge axis, below also referred to as “upper” and “lower” first hinge part, and which is provided for use with a hinge axis that extends approximately perpendicularly, the adjusting sleeves can, for example, be provided on the lower, first hinge part and a bearing sleeve can be provided on the upper, first hinge part. The bearing sleeve can have a circumferential collar which corresponds at least substantially to that of the adjusting sleeve.

This measure, even in the case of a three-part strap hinge, avoids the respective adjusting position in the direction of the hinge axis being clearly visible through different size gaps between the end faces of the upper and lower first hinge parts and the end faces of the second hinge parts facing in each case.

The adjusting sleeve can, for example, be realized so that it interacts in a frictionally engaged manner with the lower first hinge part. The term “frictionally engaged” refers to the fact that it is able to be placed damage-free onto the lower first hinge part and removed again by overcoming a frictional force, it being, however, captively mounted on the lower first hinge part and even remaining on the lower first hinge part if the strap hinge bolt is pulled for the purposes of separating the connection between the two joint hinges.

The bearing sleeve can, for example, be provided so that it interacts in a frictionally engaged manner with the strap hinge bolt. If the strap hinge bolt is displaced upwards for the purpose of releasing the connection between the two joint hinges, it entrains the bearing sleeve until the bearing sleeve abuts against the lower end face of the upper, first hinge part. This means that the spacing between the end faces of the adjusting sleeve and the bearing sleeve facing each other increases such that re-insertion of the second hinge part is made easier.

The strap hinge 100 according to the present invention, represented in the drawings, serves to connect a leaf 1 to a frame 2 so as to be hinged about a hinge axis S. It comprises a first joint hinge 3, which is provided in the majority of cases (as in the exemplary embodiment represented in the drawing) for attachment to the frame 2 and consequently is also referred to as “frame joint hinge”. Four self-tapping fastening screws 4, which pass through the first joint hinge 3 in counter bores 5, serve for fastening.

The first joint hinge 3 comprises a fastening part 6 produced from a flat material, on which two first hinge parts 7, 7′, which are spaced apart from each other in the direction of the hinge axis S, are integrally formed by bending the material. The first hinge part 7 is also referred to as the “upper first hinge part”, the hinge part 7′ accordingly also being referred to as the “lower first hinge part”.

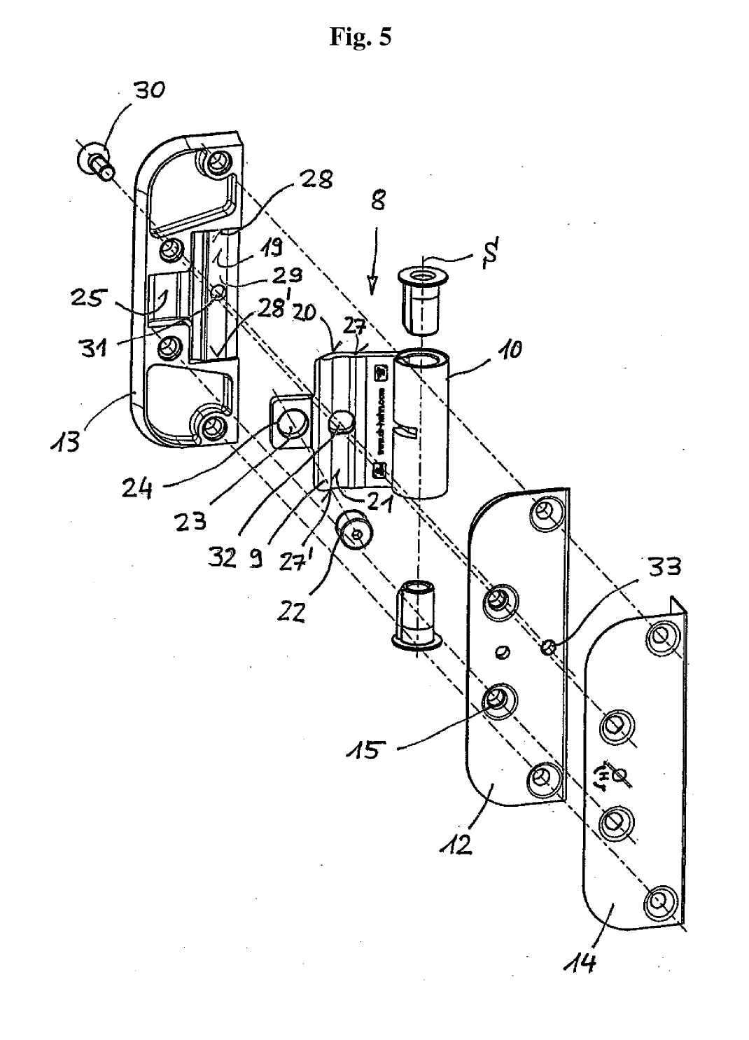

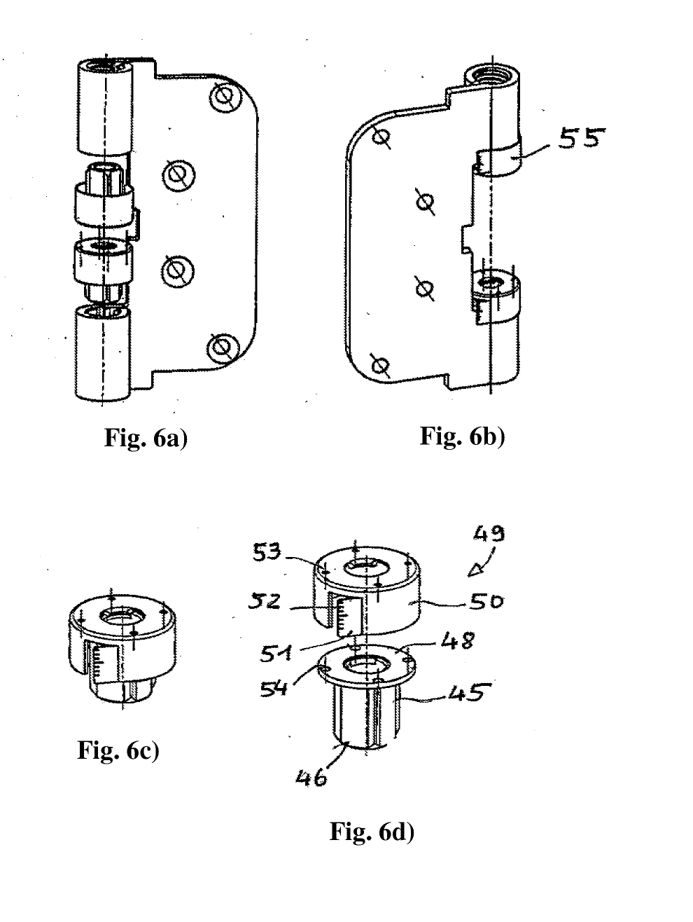

The strap hinge 100 according to the present invention furthermore comprises a second joint hinge 8, which has a second fastening part 9 which is once again formed from a flat material, and a second hinge part 10 which is integrally formed thereon (see in particular FIG. 5).

The second fastening part 9 is mounted in a strap hinge receiving element, given the overall reference of 11. It comprises a front shaped part 12, which faces the observer in the mounted state, and a rear shaped part 13, which faces away from the observer in the mounted state, as well as an angled cover piece 14, which covers the side of the front shaped part 12, which faces the observer, and the narrow side of the strap hinge receiving element 11, which faces the second hinge part 10, with the exception of counter bores 15 for the passage of fastening screws 16 and a slot 17 for the passage of the second fastening part 9 (see also FIG. 11).

The front shaped part 12 of the strap hinge receiving element 11 comprises a convex contact surface 18, and the rear shaped part 13 comprises a concave contact surface 19 which is concentric to the contact surface 18 (see FIG. 10).

A counter contact surface 20, which is realized in a complementary manner to the concave contact surface, and a concave counter contact surface 21, which is realized in a complementary manner to the convexly realized contact surface 18, are provided on the second fastening part 9 and, when the front and rear shaped parts 12, 13 are joined together, interact in a sliding manner (see also FIG. 5). This means that a tilt axis K is defined, about which the second fastening part can tilt and which is outside the second fastening part 9 dependent on the radius of curvature of the convex counter contact surface 21 (see FIG. 11).

For a tilt movement of the second fastening part 9, which serves for an adjustment displacement perpendicular to the hinge axis S in the direction of the arrow J in FIG. 11, and fixing of the second fastening part 9 in a desired position, there is provided an adjusting screw 22 in a complementary threaded bore 23 in a continuation 24 on the edge of the second fastening part 9 facing away from the second hinge part 10. The adjusting screw 22 is supported by way of its two ends on inner surfaces 25, 25′ which are realized on the front and rear shaped parts 12, 13.

In order to be able to place a tool in position on the adjusting screw 22 for rotating, there is provided a through-bore 26 which extends through the cover piece 14 and the front shaped part 12.

As can be seen in particular in FIG. 5, the upper and lower narrow sides 27, 27′ are supported on upper and lower edges 28, 28′ of a receiving chamber 29, formed by the front and rear shaped parts 12, 13, for the second hinge part 9, such that it is accommodated in a fixed manner in the direction of the hinge axis S by the strap hinge receiving element 11.

The two shaped parts 12, 13 and the cover piece 14 are pre-assembled with the second joint hinge 8 by firstly placing the front shaped part 12 onto the cover piece 14. The second fastening part 9 is then inserted into the slot 17 in the cover piece 14 until it is situated in the desired position with reference to the receiving chamber 29. The adjusting screw 22 is then screwed into the threaded bore 23 until it protrudes by approximately the same amount on both sides of the continuation 24. The rear shaped part 13 is then placed in such a manner on the second joint hinge 8 with its second fastening part 9 that the convex counter contact surface 20 abuts against the concave contact surface 19. The module is fixed by means of a connecting screw 30, which penetrates the rear shaped part 13 in a bore 31, the second fastening part 9 in a bore 32 and can be screwed into a threaded bore 33 provided in the front shaped part 12.

The fastening of the module prepared in this manner is effected by means of self-tapping fastening screws 16 (in an embodiment represented in the drawing on leaf 1).

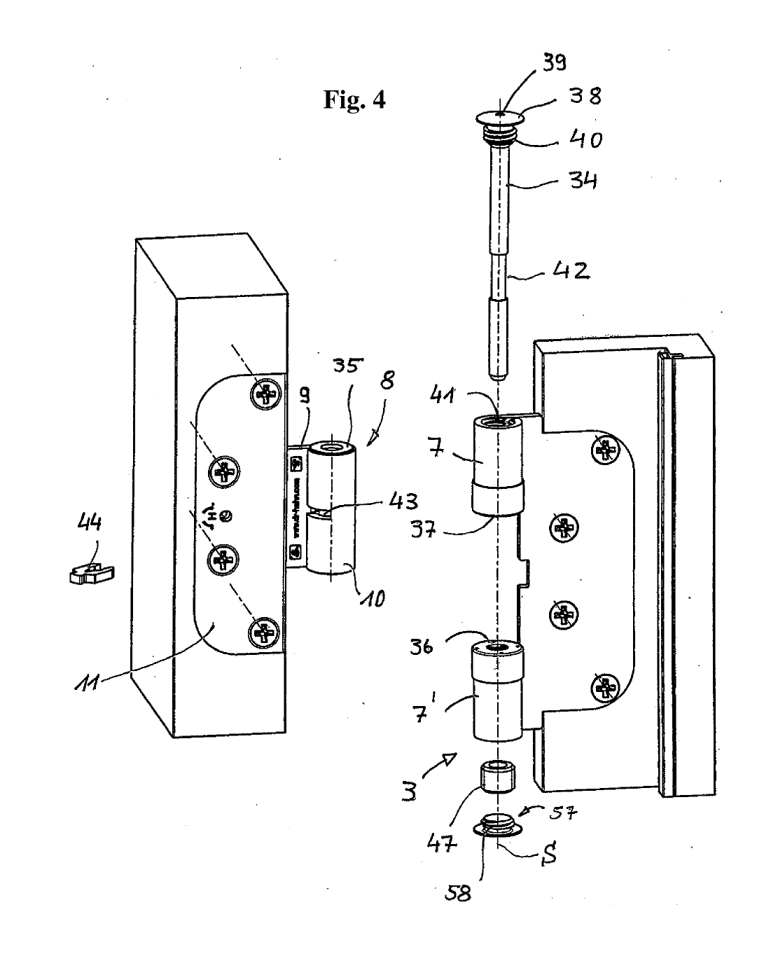

As can be seen in particular in FIG. 4, a strap hinge bolt 34 serves to connect the first joint hinge 3 to the second joint hinge 8 so as to pivot about the hinge axis S, the strap hinge bolt being insertable through the first and second hinge parts 7, 7′; 10. Bearing bushes 35, 36, 37 are provided in the hinge parts for the at least substantially play-free, low-friction accommodation of the strap hinge bolt.

At its upper end, the strap hinge bolt has a flat head 38 with an arrangement 39 for a lathe tool to be placed in position thereon. The external diameter of the head 38 corresponds to the external diameter of the first hinge part 7. Below the head 38 is provided an external thread 40, which is realized in a complementary manner to an internal thread 41 provided at the upper end of the upper first hinge part 7.

For the connection between the first and second joint hinges so as to be pivotable about the hinge axis S, with the strap hinge bolt 34 tightened, the first and second hinge parts 7, 7′; 10 are moved into a position in alignment with each other, the strap hinge bolt 34 is introduced from above and finally rotated until the under side of the head 38 abuts against the top side of the upper first hinge part 7.

In order to prevent the strap hinge bolt 34 being able to be dismantled with the leaf closed, it has a region 42 with a reduced diameter. In the mounted state, the region is situated inside the second hinge part 10. This latter has a slot 43, through which a clamping-fork-like locking element 44 can be inserted. This is realized in such a manner that its tines abut against the outer periphery of the region 42 with resilient prestressing.

As can be seen in FIG. 4, the length of the region 42 is considerably greater than the thickness of the locking element 44. This means that the second hinge part 10 can be displaced in the direction of the hinge axis S between the upper and lower first hinge parts 7, 7′ without the strap hinge bolt 34 having had to be displaced for this purpose.

To this end, the sides of the upper and lower first hinge parts facing each other are spaced apart by an amount that is greater than the length of the second hinge part 10. For the purposes of adjustment in the direction of the hinge axis S, the bearing bush 36 of the lower first hinge part 7′ is realized as an adjusting sleeve 45, which is supported by way of its lower edge 46 on an adjusting spindle 47, which can be screwed from below into an internal thread provided in the lower, first hinge part 7′.

At its upper end, the adjusting sleeve 45 comprises a radially protruding collar 48, the external diameter of which corresponds approximately to the external diameter of the lower first hinge part 7′. It bears a cap 49, the cylindrical lateral surface 50 of which has such an inner circumference that the cap 49 abuts against the lower first hinge part 7′ with a frictional engagement.

The cap 49 has a tongue 51 which protrudes out of the lateral surface 50 forming a circumferential collar, on which tongue is provided a scale 52 for indicating the adjustment position in the direction of the hinge axis S.

The cap 49 has downwardly directed bulges 53, which engage in complementary recesses 54 provided on the collar 48 in order to provide security against rotation in this manner between the cap 49 and the adjusting sleeve 45.

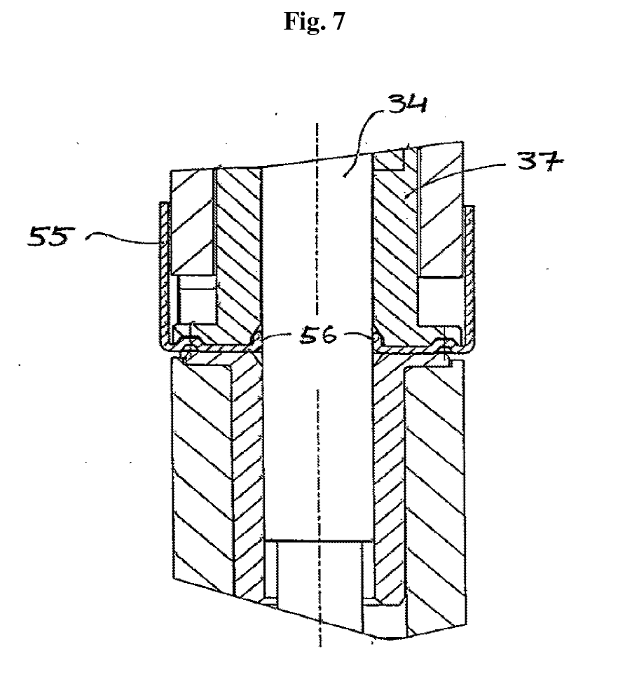

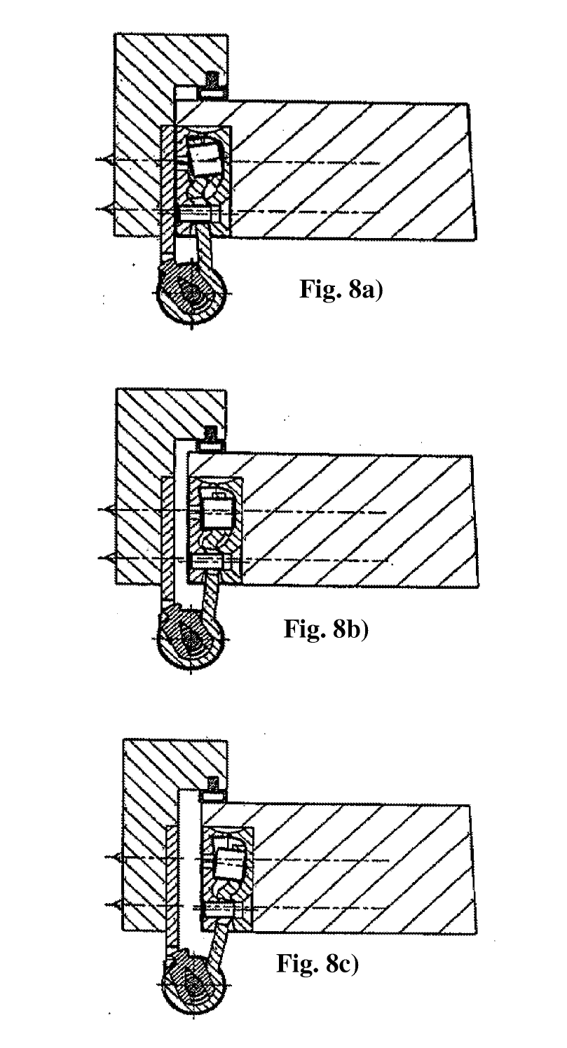

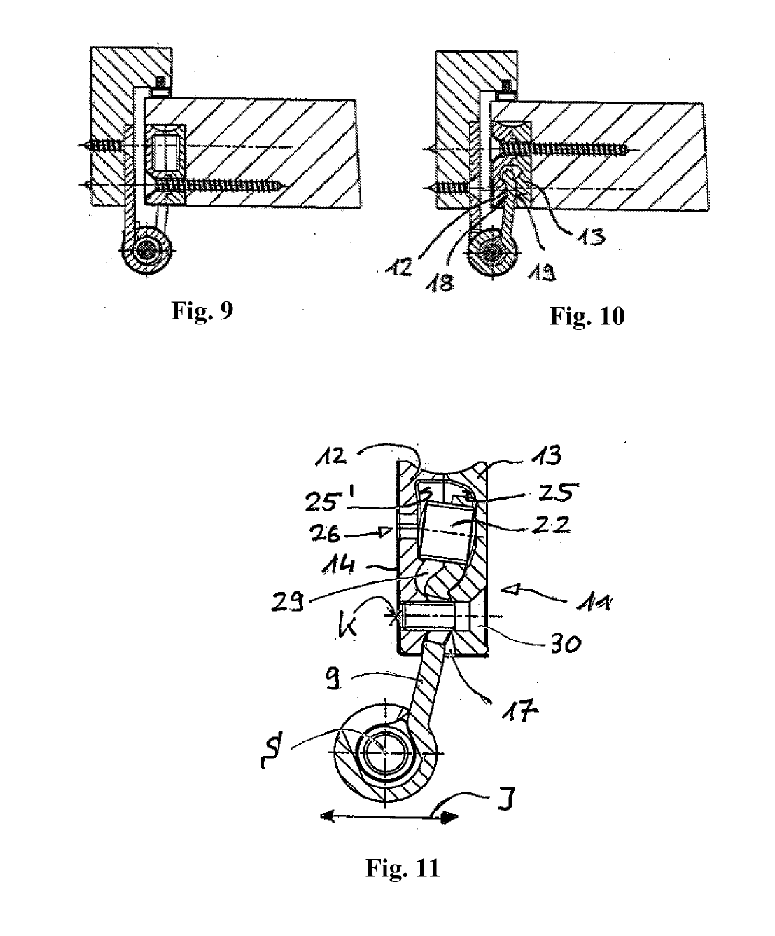

The bearing bush 37 provided on the upper first hinge part 7 has a cap 55, the external development of which corresponds to that of the cap 49 and reference consequently being made to the description thereof. The cap 55 (as can be seen in particular in FIG. 7) comprises inner projections 56, by means of which the cap 55 interacts in a frictionally engaged manner with the strap hinge bolt 34. On account of this arrangement, when the strap hinge is tightened, the bearing bush 37 is entrained upwards until it abuts against the under side of the upper first hinge part 7 and thus, the spacing between the bearing sleeves 36, 37 is increased, as a result of which inserting the second hinge part 10 is made easier.

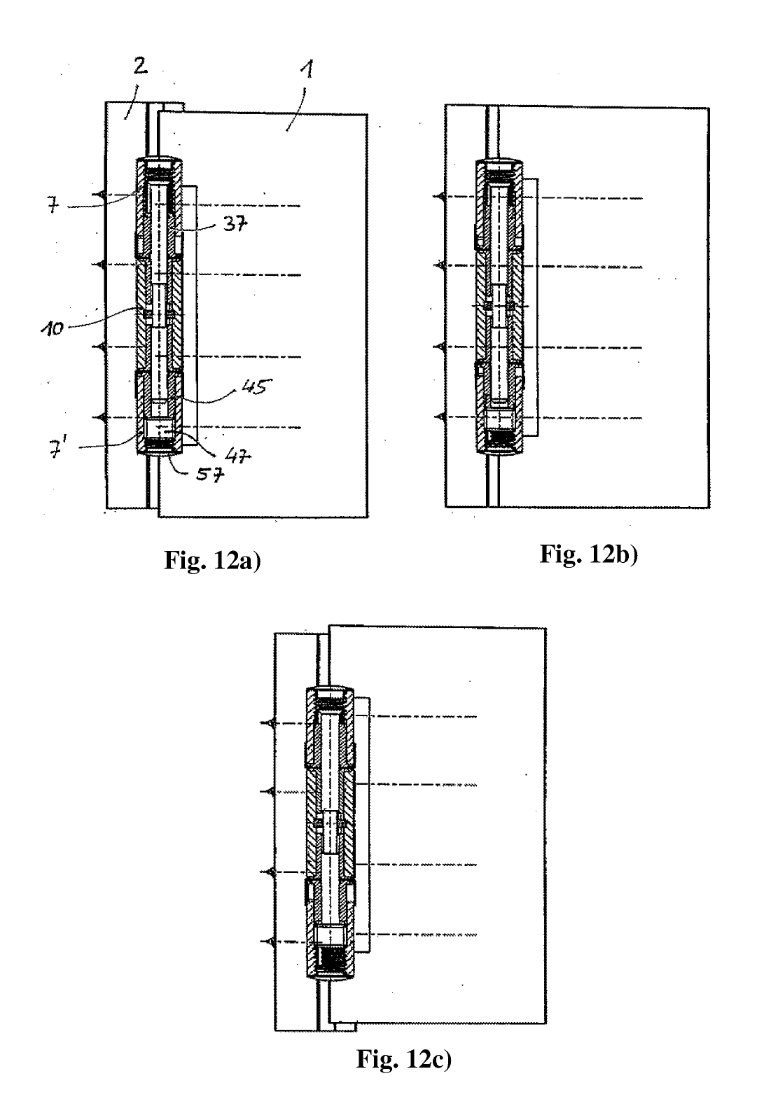

Adjustment of the second joint hinge 8 in relation to the first joint hinge 3 in the direction of the hinge axis S can be effected by rotating the adjusting spindle 47 (as is obvious in particular by way of FIGS. 12a) to c)) which show the strap hinge 100 in different adjustment positions.

To improve the visual impression, there is provided a threaded cap 57 with an external thread 58 that corresponds to the adjusting spindle 47, the threaded cap being screwed into the lower first hinge part 7′ once the adjusting operation has been completed.

The present invention is not limited to embodiments described herein; reference should be had to the appended claims.

### LIST OF REFERENCES

100 Strap hinge
1 Leaf
2 Frame
3 First joint hinge
4 Fastening screws
5 Counter bores
6 First fastening part
7,7′ First hinge part
8 Second joint hinge
9 Second fastening part
10 Second hinge part
11 Strap hinge receiving element
12 Front shaped part
13 Rear shaped part
14 Cover piece
15 Counter bores
16 Fastening screws
17 Slot
18 Convex contact surface
19 Concave contact surface
20 Convex counter contact surface
21 Concave counter contact surface
22 Adjusting screw
23 Threaded bore
24 Continuation
25, 25′ Inner surfaces
26 Through-bore
27, 27′ Narrow sides
28, 28′ Edges
29 Receiving chamber
30 Connecting screw
31 Bore
32 Bore
33 Threaded bore
34 Strap hinge bolt
35 Bearing bush
36 Bearing bush
37 Bearing bush
38 Head
39 Arrangement
40 External thread
41 Internal thread
42 Region
43 Slot
44 Locking element
45 Adjusting sleeve
46 Edge
47 Adjusting spindle
48 Collar
49 Cap
50 Lateral surface
51 Tongue
52 Scale
53 Bulges
54 Recesses
55 Cap
56 Projections
57 Threaded cap
58 Thread
J Direction of adjustment
K Tilt axis
S Hinge axis

What is claimed is:

1. A strap hinge for connecting a leaf to a frame so as to pivot about a hinge axis, the strap hinge comprising:
a first joint hinge with a first fastening part and a first hinge part; and
a second joint hinge with a second fastening part and a second hinge part, the second hinge part being arranged in a strap hinge receiving element, the first joint hinge being connected to the second joint hinge so as to pivot about the hinge axis, and the second hinge part being configured so as to be tiltable about a tilt axis extending approximately parallel to the hinge axis,
wherein
the tilt axis is defined by at least one contact surface, which, when viewed in the direction of the tilt axis, is curved in a shape of a part of a circle, the at least one contact surface being arranged on the strap hinge receiving element and configured to abut against a respective counter contact surface arranged on the second fastening part, the respective counter contact surface being curved in an approximately complementary manner to the at least one contact surface.

2. The strap hinge as recited in claim 1, wherein two counter contact surfaces arranged at a constant spacing from each other are arranged on the second fastening part, and two contact surfaces, which two contact surfaces are complementary to the two counter contact surfaces, are arranged on the strap hinge receiving element, wherein a spacing between the two contact surfaces corresponds at least approximately to a spacing between the two counter contact surfaces.

3. The strap hinge as recited in claim 1, wherein the at least one contact surface and the respective counter contact surface each have a radii of curvature so that the tilt axis lies outside the second fastening part.

4. The strap hinge as recited in claim 1, further comprising an adjusting screw configured to bring about a tilting movement of the second fastening part about the tilt axis.

5. The strap hinge as recited in claim 4, wherein the second fastening part includes a threaded bore configured to receive the adjusting screw, and wherein the strap receiving element includes inner surfaces configured to support ends of the adjusting screw.

6. The strap hinge as recited in claim 4, wherein the adjusting screw is arranged on an end region of the second fastening part remote from the second hinge part.

7. The strap hinge as recited in claim 1, wherein the strap hinge receiving element is divided in a parting plane extending parallel to the tilt axis between the at least one contact surface.

8. A strap hinge for connecting a leaf to a frame so as to pivot about a hinge axis, the strap hinge comprising:
a first joint hinge with a first fastening part and a first hinge part; and
a second joint hinge with a second fastening part and a second hinge part, the second hinge part being arranged in a strap hinge receiving element, the first joint hinge being connected to the second joint hinge so as to pivot about the hinge axis, and the second hinge part being configured so as to be tiltable about a tilt axis extending approximately parallel to the hinge axis,
wherein,
the tilt axis is defined by at least one contact surface, which, when viewed in the direction of the tilt axis, is curved in a shape of a part of a circle, the at least one contact surface being arranged on the strap hinge receiving element and configured to abut against a respective counter contact surface arranged on the second fastening part, the respective counter contact surface being curved in an approximately complementary manner to the at least one contact surface,
the hinge axis is defined by a strap hinge bolt having a region with a reduced diameter, the strap hinge bolt being configured to engage in the first hinge part and in the second hinge part, and
a locking element is configured to be introduced into a receiving means arranged in at least one of the first hinge part and the second hinge part with the leaf in an open position, and the locking element is also configured to interact in an introduced state with the region with a reduced diameter.

9. The strap hinge as recited in claim 8, wherein the locking element is clamping-fork-like with forks configured to abut against the region with a reduced diameter in the introduced state.

10. The strap hinge as recited in claim 9, wherein the forks are configured to abut with resilient prestressing.

11. The strap hinge as recited in claim 8, wherein the strap hinge bolt includes an external thread at one end region, and the first hinge part includes an internal thread complementary to the external thread.

12. A strap hinge for connecting a leaf to a frame so as to pivot about a hinge axis, the strap hinge comprising:
a first joint hinge with a first fastening part and a first hinge part having an internal thread;
a second joint hinge with a second fastening part and a second hinge part, the first joint hinge being connected to the second joint hinge so as to pivot about the hinge axis;
an adjusting spindle having an external thread, the adjusting spindle being configured to be screwed into the internal thread of the first hinge part;
an adjusting sleeve having a first end and a second end, the first end being supported on the adjusting spindle and the second end abutting against an end face of the second hinge part;
a circumferential collar arranged on the adjusting sleeve, the circumferential collar being configured to at least partly cover an outer periphery of the first hinge part; and
a protruding tongue with a scale on an outer surface thereof is provided on the circumferential collar.

13. The strap hinge as recited in claim 12, wherein the first hinge part includes a first upper hinge part and a first lower hinge part spaced apart from each other in the direction of the hinge axis, and further comprising a bearing sleeve arranged on the first upper hinge part, the bearing sleeve having a circumferential collar which substantially corresponds to the circumferential collar arranged on the adjusting sleeve, and wherein the adjusting sleeve is arranged on the first lower hinge part, and the strap hinge is provided for use with the hinge axis extending approximately perpendicularly.

14. The strap hinge as recited in claim 13, wherein the adjusting sleeve is configured to interact in a frictionally engaged manner with the lower first hinge part.

15. The strap hinge as recited in claim 13, wherein the bearing sleeve is configured to interact in a frictionally engaged manner with the strap hinge bolt.
